(19) United States
(12) Patent Application Publication
(10) Pub. No.: US 2007/0133683 A1
(43) Pub. Date: Jun. 14, 2007

(54) Motion vector estimation device and motion vector estimation method

(76) Inventor: Hideyuki Ohgose, Osaka (JP)

Correspondence Address: MCDERMOTT WILL & EMERY LLP, 600 13TH STREET, N.W., WASHINGTON, DC, 20005-3096, US

(21) Appl. No.: 11/607,002

(22) Filed: Dec. 1, 2006

(30) Foreign Application Priority Data
Dec. 9, 2005 (JP) 2005-357028

(51) Int. Cl. H04N 11/02; H04N 11/04

(52) U.S. Cl. 375/240.16; 375/240.24

(57) ABSTRACT

A moving picture estimation device and a moving picture estimation method which allow estimation of accurate motion vectors while reducing an amount of processing are provided. A moving picture coding apparatus includes: a reduced picture generation unit which generates a reduced current picture to be coded and candidate reduced reference pictures respectively from an input picture including a current block to be coded and candidate reference pictures; a picture division unit which divides a reduced current picture into areas; an area motion vector estimation unit which estimates, for each area, an area motion vector with respect to each candidate reduced reference picture; a correlation calculation unit which calculates, for each area, a correlation of each area motion vector; a reference picture selection unit which selects, for each area, one reference picture from among candidate reference pictures, based on the area motion vector and the correlation of the area motion vector; and a coding unit including a motion estimation unit which estimates the motion vector of the current block using the selected reference picture.

### BACKGROUND OF THE INVENTION

(1) Field of the Invention

The present invention relates to a motion vector estimation device and a motion vector estimation method used in a picture coding apparatus which codes a moving picture by performing inter-picture prediction.

(2) Description of the Related Art

In an image compression scheme, such as Moving Picture Experts Group (MPEG) standards, that uses a correlation between pictures of a moving picture, motion vectors must be estimated per block on which motion compensation is performed. In order to estimate accurate motion vectors, a method of improving the accuracy when estimating motion vectors by expanding a search range is generally used. However, the expanded search range requires an increased amount of processing and thus increased memory capacity because the required amount of processing is determined depending on the number of blocks to be processed multiplied by the search range. Thus, there is a need to estimate motion vectors with high accuracy without expanding the search range.

As such a method of estimating motion vectors with high accuracy without expanding the search range, there has been proposed a moving picture coding apparatus which determines a search range based on the size of the motion vector estimated in the past and the type of the corresponding macroblock (for example, refer to Japanese Laid-open Patent Application No. 11-112993).

However, in the case of determining the search range based on the size of the motion vector estimated in the past and the type of the corresponding macroblock as mentioned above, the motion vector estimated in the past needs to be stored and thus increased memory capacity is required. This is a problem in the conventional method.

Incidentally, the H.264 standard allows up to 16 reference pictures to be used for inter-picture prediction. Since the conventional MPEG-2 standard only allows up to two reference pictures to be used, the H.264 standard allows estimation of more accurate motion vectors. However, if motion vectors are estimated with respect to all the reference pictures, the H.264 standard requires eight times as much processing as that in the MPEG-2 standard, which is a very large amount of processing. This is also a problem in the conventional method.

### SUMMARY OF THE INVENTION

The present invention has been conceived in view of the above-mentioned circumstances, and has an object to provide a motion vector estimation device and a motion vector estimation method which allow estimation of accurate motion vectors while reducing the amount of processing.

In order to achieve the above object, the motion vector estimation device according to the present invention is a motion vector estimation device which estimates, with respect to a reference picture, a motion vector of a current block included in a current picture to be coded. This motion vector estimation device includes: a reduced picture generation unit which generates a reduced current picture and candidate reduced reference pictures by reducing the number of pixels of the current picture and candidate reference pictures respectively; a picture division unit which divides the reduced current picture into areas; an area motion vector estimation unit which estimates, for each of the candidate reduced reference pictures, an area motion vector which is a motion vector of each of the areas with respect to the candidate reduced reference picture; a correlation calculation unit which calculates, for each of the candidate reduced reference pictures, a correlation between an image of each of the areas and a predicted area image generated from the area motion vector and the candidate reduced reference picture; a reference picture selection unit which selects, based on the correlation, at least one reference picture for each of the areas from among the candidate reference pictures; and a motion estimation unit which estimates a motion vector of the current block included in the area, using the reference picture selected for the area by the reference picture selection unit. With this structure, it is possible to determine the reference picture based on the correlation of the area motion vector and estimate the motion vector of the current block with high accuracy while reducing the amount of processing by efficiently reducing the number of reference pictures in which the motion vector is searched for the current block.

The above-mentioned reference picture selection unit may select a reference picture corresponding to the candidate reduced reference picture with a high correlation, from among the candidate reference pictures. With this structure, it is possible to determine the reference picture based on the area motion vector and the correlation of the area motion vector and estimate the motion vector of the current block with high accuracy while reducing the amount of processing by efficiently reducing the number of reference pictures in which the motion vector is searched for the current block.

The above-mentioned motion vector estimation device further includes a search range determination unit which determines information regarding a motion vector search range for the current block based on the area motion vector, and the above-mentioned motion estimation unit may determine the motion vector search range in the reference picture selected by the reference picture selection unit, based on the information regarding the motion vector search range determined by the search range determination unit, and estimate the motion vector of the current block by searching within the determined motion vector search range. With this structure, the information regarding the motion vector search range, such as the size of the motion vector search range for the current block, the shift amount of the motion vector search range, the amount of search position decimation at the time of searching the motion vector, and the amount of pixel decimation in calculating the evaluation value of the block, is determined based on the area motion vector. This determination of the information makes it possible to determine the motion vector search range efficiently. Therefore, it is possible to estimate the motion vector of the current block with high accuracy.

The above-mentioned search range determination unit may determine the information regarding the motion vector search range based on the area motion vector and the correlation. With this structure, the information regarding the motion vector search range is determined based on the area motion vector and the correlation of the area motion vector. This makes it possible to determine the motion vector search range much more efficiently. Therefore, it is possible to estimate the motion vector of the current block with higher accuracy.

Note that it is possible to embody the present invention not only as such a motion vector estimation device, but also as a motion vector estimation method including, as steps, the characteristic units of the motion vector estimation device, as well as a program for causing a computer to execute these steps. Furthermore, such a program can be distributed by recording on media including CD-ROM and over transmission media including the Internet.

### FURTHER INFORMATION ABOUT TECHNICAL BACKGROUND TO THIS APPLICATION

The disclosure of Japanese Patent Application No. 2005-357028 filed on Dec. 9, 2005 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram which shows a structure of a moving picture coding apparatus including a motion vector estimation device according to the first embodiment of the present invention;

FIG. 2 is a block diagram which shows a structure of a coding unit of the moving picture coding apparatus;

FIG. 3 is a flowchart which shows a sequence of operations for selecting one reference picture from among candidates for the reference picture;

FIG. 4A is a diagram which shows a reduced current picture which is divided into areas;

FIG. 4B is a diagram which shows a matching between an area B and an area in a candidate reduced reference picture;

FIG. 4C is a diagram which shows an equation for calculating a correlation between a current picture and a reference picture;

FIG. 5 is a diagram which illustrates how to estimate area motion vectors with respect to respective candidate reduced reference pictures;

FIG. 6 is a diagram which illustrates how to estimate area motion vectors from respective areas with respect to candidate reduced reference pictures;

FIG. 7 is a block diagram which shows a structure of a moving picture coding apparatus including a motion vector estimation device according to the second embodiment of the present invention;

FIG. 8 is a flowchart which shows a sequence of operations for selecting a reference picture and determining information regarding a motion vector search range;

FIG. 9 is a flowchart which shows a sequence of operations for determining information regarding a motion vector search range;

FIG. 10 is a diagram which illustrates how to shift the position of a motion vector search range;

FIG. 11 is a diagram which illustrates the size of a motion vector search range and how to shift the position of the range;

FIG. 12 is a diagram which illustrates an amount of search position decimation;

FIG. 13 is a diagram which illustrates an amount of pixel decimation for calculation of an evaluation value in a motion vector search process;

FIG. 14 is a diagram which illustrates a method for setting search ranges in a motion vector estimation apparatus according to the third embodiment of the present invention;

FIG. 15 is a diagram which illustrates another method for setting search ranges in the motion vector estimation apparatus according to the third embodiment of the present invention; and

FIG. 16 is a diagram which illustrates a method for correcting information regarding a motion vector search range in a motion vector estimation device according to the fourth embodiment of the present invention.

### DESCRIPTION OF THE PREFERRED EMBODIMENTS

Preferred embodiments of the present invention will hereinafter be described with reference to the drawings.

### First Embodiment

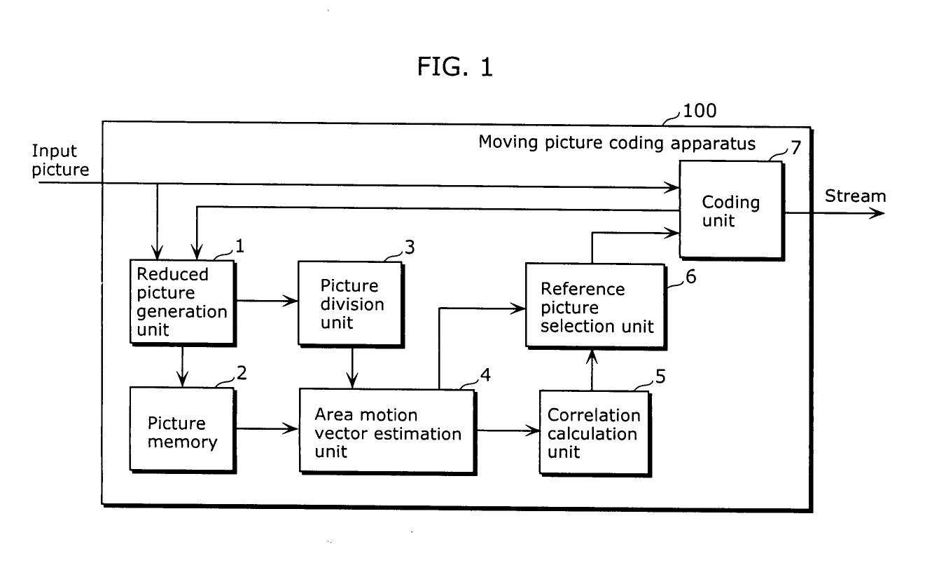

FIG. 1 is a block diagram which shows a structure of a moving picture coding apparatus including a motion vector estimation device according to the first embodiment of the present invention.

A moving picture coding apparatus 100 is intended for coding an input moving picture on a block-by-block basis, and includes, as shown in FIG. 1, a reduced picture generation unit 1, a picture memory 2, a picture division unit 3, an area motion vector estimation unit 4, a correlation calculation unit 5, a reference picture selection unit 6 and a coding unit 7. Note that it is assumed in the present embodiment that the coding unit 7 performs coding according to the H.264 standard. It is also assumed that a single rectangular area is searched in the motion vector estimation process which is actually performed by the coding unit 7 on a per macroblock basis.

The reduced picture generation unit 1 receives a current picture to be coded (an input picture) including a current macroblock to be coded (a current block) as well as candidate reference pictures which can be referred to for estimation of a motion vector used for coding the current block, and calculates the peripheral pixels to be reduced from the current picture and the candidate reference pictures so as to generate a reduced current picture to be coded and candidate reduced reference pictures each having the reduced pixels. Although the reduced picture generation unit 1 calculates the peripheral pixels to be reduced from the current picture and the candidate reference pictures respectively so as to generate a reduced current picture and candidate reduced reference pictures, the present invention is not limited to such structure and the reduced picture generation unit 1 may just decimate a part of the pixels included in the pictures. The candidate reduced reference pictures generated by the reduced picture generation unit 1 are stored into the picture memory 2.

The picture division unit 3 divides the reduced current picture generated by the reduced picture generation unit 1 into a number of areas. The area motion vector estimation unit 4 estimates an area motion vector with respect to each candidate reduced reference picture generated by the reduced picture generation unit 1, for each area obtained by the picture division unit 3. More specifically, the area motion vector estimation unit 4 calculates the position of the image area, which is included in a candidate reduced reference picture and is most similar to a target area of the current picture, and estimates the motion vector indicating this position as the area motion vector with respect to the candidate reduced reference picture. The area motion vector estimation unit 4 performs the above operation for each area with respect to each candidate reduced reference picture so as to estimate the area motion vector with respect to each candidate reduced reference picture.

The correlation calculation unit 5 calculates, for each area, the correlation which is an index indicating a likelihood of the area motion vector with respect to each candidate reduced reference picture, which is estimated by the area motion vector estimation unit 4. More specifically, the correlation calculation unit 5 calculates the correlation of the area motion vector of each area using the covariance of the image values of the area and the image values of the image area which is included in the candidate reduced reference picture and indicated by the area motion vector. Then, the correlation calculation unit 5 performs the above operation for each area motion vector with respect to each candidate reduced reference picture so as to obtain the correlation for each area motion vector of the area.

The reference picture selection unit 6 selects, for each area, one reference picture from among candidate reference pictures which can be referred to for estimation of a motion vector of a current block to be coded, based on the area motion vectors estimated by the area motion vector estimation unit 4 and the correlations for the area motion vectors calculated by the correlation calculation unit 5.

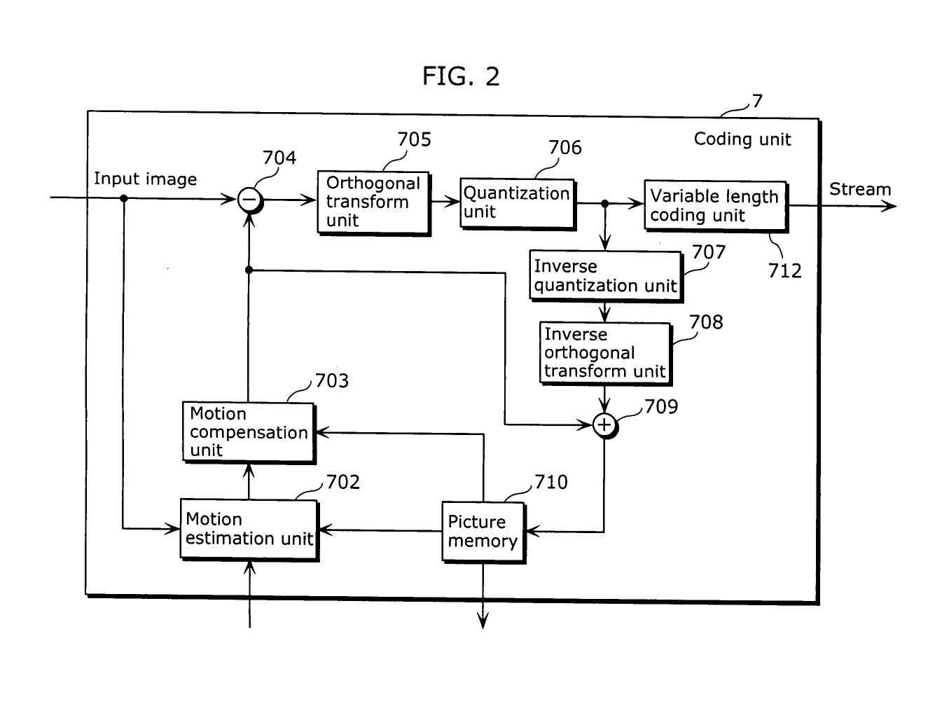

FIG.2 is a block diagram which shows the structure of the coding unit 7 of the moving picture coding apparatus 100.

The coding unit 7 includes a motion estimation unit 702, a motion compensation unit 703, a difference calculation unit 704, an orthogonal transform unit 705, a quantization unit 706, an inverse quantization unit 707, an inverse orthogonal transform unit 708, an addition unit 709, a picture memory 710, and a variable length coding unit 712. Note that intra-prediction is performed for I pictures and intra-macroblocks according to the H.264 standard. However, a description thereof is not given in the present embodiment, which focuses on the description of motion compensation.

An input picture is inputted to the motion estimation unit 702 and the difference calculation unit 704.

The motion estimation unit 702 estimates the motion vector of the current block using the reference picture selected by the reference picture selection unit 6. More specifically, the motion estimation unit 702 searches within a predetermined motion vector search range determined in the reference picture selected by the reference picture selection unit 6. By doing so, it locates an image area which is most similar to the current block and estimates the motion vector indicating the position of the image area. Here, the image area which is most similar to the current block is, for example, an image area having the smallest sum of absolute differences (SAD), from among the SADs between the pixel values of respective search ranges included in the reference picture and the pixel values of the current block. Note that the H.264 standard allows variable block-size motion vector estimation and motion compensation for each current macroblock to be coded of 16 pixels by 16 pixels (16×16), with block sizes of 16×16, 16×8, 8×16, 8×8, 8×4, 4×8, 4×4 and the like.

The motion compensation unit 703 extracts the optimal image area for a predicted image from decoded pictures (reference pictures) stored in the picture memory 710, using the motion vector estimated by the motion estimation unit 702, and generates the predicted image.

On the other hand, when receiving the input picture, the difference calculation unit 704 calculates the difference value between the image of a current block in the input picture and the predicted image, and outputs this difference value to the orthogonal transform unit 705. The orthogonal transform unit 705 transforms the difference value into frequency coefficients and outputs the resulting coefficients to the quantization unit 706. The quantization unit 706 quantizes the inputted frequency coefficients, and outputs the resulting quantized values to the variable length coding unit 712.

The inverse quantization unit 707 inversely quantizes the inputted quantized values so as to reconstruct frequency coefficients, and outputs the resulting coefficients to the inverse orthogonal transform unit 708. The inverse orthogonal transform unit 708 inversely frequency transforms the frequency coefficients into differential pixel values, and outputs the resulting values to the addition unit 709. The addition unit 709 adds the differential pixel values to the predicted image values outputted from the motion compensation unit 703 so as to obtain a decoded picture. The variable length coding unit 111 performs variable length coding of the quantized values, the motion vectors and the like, and outputs a stream.

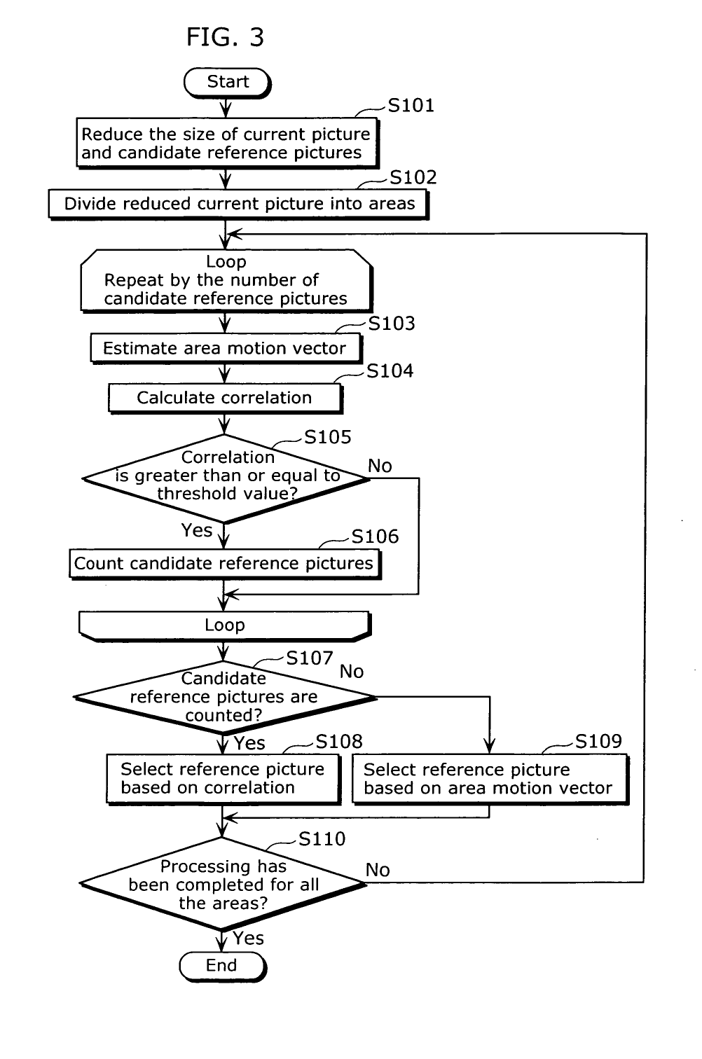

Next, a description is given as to the operations of the moving picture coding apparatus 100 including the motion vector estimation device structured as mentioned above. FIG. 3 is a flowchart which shows a sequence of operations performed for selecting one reference picture from among candidate reference pictures which can be referred to.

First, the reduced picture generation unit 1 receives a current picture to be coded. The current picture to be coded is made up of, for example, 1920 pixels×1080 pixels, and includes a current block to be coded. Since it is assumed in the present embodiment that coding is performed according to the H.264 standard, the current block is a macroblock made up of 16 pixels×16 pixels. The reduced picture generation unit 1 reduces the size of the current picture and generates a reduced current picture.

In addition, the reduced picture generation unit 1 receives candidate reference pictures which have been locally decoded by the coding unit 7 and can be referred to for estimation of a motion vector used for coding the current block. As with the current picture, the locally-decoded reference picture is made up of, for example, 1920 pixels×1080 pixels. The reduced picture generation unit 1 reduces the size of each candidate reference picture and generates a candidate reduced reference picture (Step S101). Then, the reduced reference picture generated by the reduced picture generation unit 1 is stored into the picture memory 2.

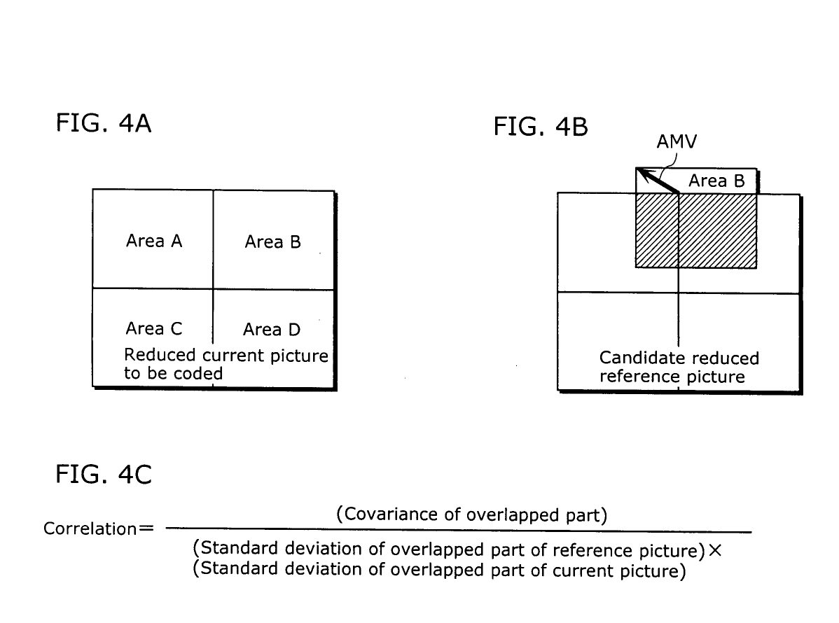

Next, the picture division unit 3 divides the reduced current picture generated by the reduced picture generation unit 1 into a number of areas (Step S102). Here, as shown in FIG. 4A, the reduced current picture is divided into two both horizontally and vertically so as to divide it into four areas A, B, C and D.

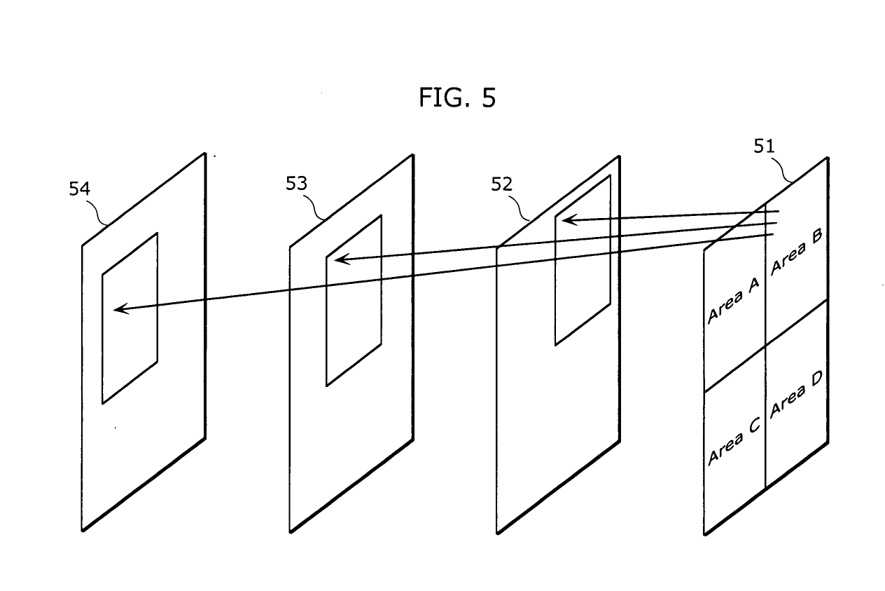

Next, the area motion vector estimation unit 4 estimates, for each area obtained by the picture division unit 3, an area motion vector with respect to each candidate reduced reference picture generated by the reduced picture generation unit 1 (Step S103). For example, as shown in FIG. 4B, when estimating an area motion vector AMV of the area B, the area motion vector estimation unit 4 calculates the evaluation value by performing matching using only the part overlapped with the candidate reduced reference picture. Since the evaluation value becomes small if the overlapped part is small, a value corrected based on the size of the overlapped part is calculated as the evaluation value. Subsequently, the area motion vector estimation unit 4 calculates the position which enables to provide the minimum corrected evaluation value so as to estimate the motion vector indicating this position as the area motion vector AMV with respect to the candidate reduced reference picture. Assuming that there are, for example, three candidate reference pictures, the area motion vector estimation unit 4 first estimates an area motion vector with respect to a first candidate reduced reference picture 52, as shown in FIG. 5. Note that the present invention is not limited to such matching performed using only the part overlapped with the candidate reduced reference picture. Matching may be performed using the whole area, for example, after filling the area surrounding the candidate reduced reference picture with the pixel data.

Next, the correlation calculation unit 5 calculates a correlation which is an index indicating the likelihood of the area motion vector AMV estimated by the area motion vector estimation unit 4 (Step S104). More specifically, the correlation calculation unit 5 calculates, using the equation shown as FIG. 4C, the degree of the correlation of the overlapped part corresponding to the likelihood of the area motion vector AMV, as shown in FIG. 4B, by calculating the covariance of the overlapped part. Here, the covariance of the overlapped part is calculated. However, it should be noted that other indices such as a sum of absolute differences of the pixel values of the overlapped part may be used.

Next, the reference picture selection unit 6 determines whether or not the correlation of the area motion vector AMV calculated by the correlation calculation unit 5 is greater than or equal to a predetermined threshold value (Step S105). As a result, when the correlation of the area motion vector AMV is greater than or equal to the predetermined threshold value (Yes in Step S105), the reference picture selection unit 6 starts counting candidate reference pictures (Step S106). On the other hand, when the correlation of the area motion vector AMV is lower than the predetermined threshold value (No in Step S105), the reference picture selection unit 6 does not count candidate reference pictures.

The operations from the process of estimating an area motion vector (Step S103) through the process of counting candidate reference pictures (Step S106) are repeated as many times as the number of the candidate reference pictures which can be referred to for estimation of a motion vector of a current block. More specifically, in the above example, a area motion vector is estimated with respect to the second candidate reduced reference picture 53, as shown in FIG. 5, the correlation is calculated and determined, and then the process of counting candidate reference pictures is performed. Next, an area motion vector is estimated with respect to the third candidate reduced reference picture 54, the correlation is calculated and determined, and then the process of counting candidate reference pictures is performed.

Next, the reference picture selection unit 6 determines whether or not candidate reference pictures are counted (Step S107). As a result, when the candidate reference pictures are counted (Yes in Step S107), the reference picture selection unit 6 selects, as a reference picture, the picture with the highest correlation, from among the pictures having the correlations which are greater than or equal to the predetermined threshold value (Step S108). On the other hand, when the candidate reference pictures are not counted (No in Step S107), namely, when there is no picture having the correlation which is greater than or equal to the predetermined threshold value, the reference picture selection unit 6 selects, as a reference picture, the picture to which the area motion vector with the smallest value points (Step S109).

Next, the reference picture selection unit 6 determines whether or not it has selected reference pictures for all the areas (Step S110). As a result, when it has selected the reference pictures for all the areas (Yes in Step S110), the process for one current picture ends. On the other hand, when it has not yet selected the reference pictures for all the areas (No in Step 5110), the operations from the process of estimating area motion vectors (Step S103) through the process of selecting reference pictures (Step S108 or Step S109) are repeated.

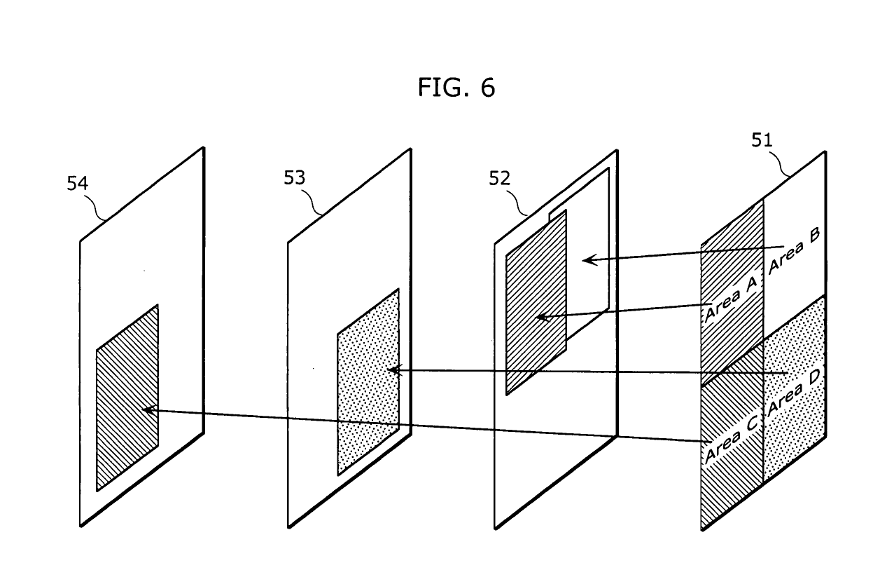

As a result of the operations, a reference picture corresponding to the candidate reduced reference picture 52 is selected for the areas A and B of the reduced current picture, a reference picture corresponding to the candidate reduced reference picture 54 is selected for the area C, and a reference picture corresponding to the candidate reduced reference picture 53 is selected for the area D, as shown in FIG. 6.

Then, the motion estimation unit 702 of the coding unit 7 estimates the motion vector of the current block using the reference picture selected by the reference picture selection unit 6.

As described above, in the present embodiment, one reference picture is selected from among the candidate reference pictures which can be referred to, based on the area motion vector estimated by the area motion vector estimation unit 4 and the correlation calculated by the correlation calculation unit 5. Accordingly, it is possible to estimate an accurate motion vector while reducing the number of candidate reference pictures within which motion vectors are searched, and thus improve the coding efficiency.

Note that although the present embodiment describes a sequence of operations for selecting one reference picture from among candidate reference pictures which can be referred to, the present invention is not limited to these operations. For example, two reference pictures may be selected. In this case, after selecting the first reference picture by the above-mentioned method, the reference picture selection unit 6 selects, as a second reference picture, another candidate reference picture with the second highest correlation. Alternatively, if there is only one candidate reference picture with a correlation of a predetermined threshold value or higher, the reference picture selection unit 6 selects, as a second reference picture, one of the candidate reference pictures with correlations lower than the threshold value, to which the area motion vector with the smallest value points. Furthermore, it is also possible to select three reference pictures from among four or more candidate reference pictures which can be referred to, using a method similar to the above-mentioned method.

### Second Embodiment

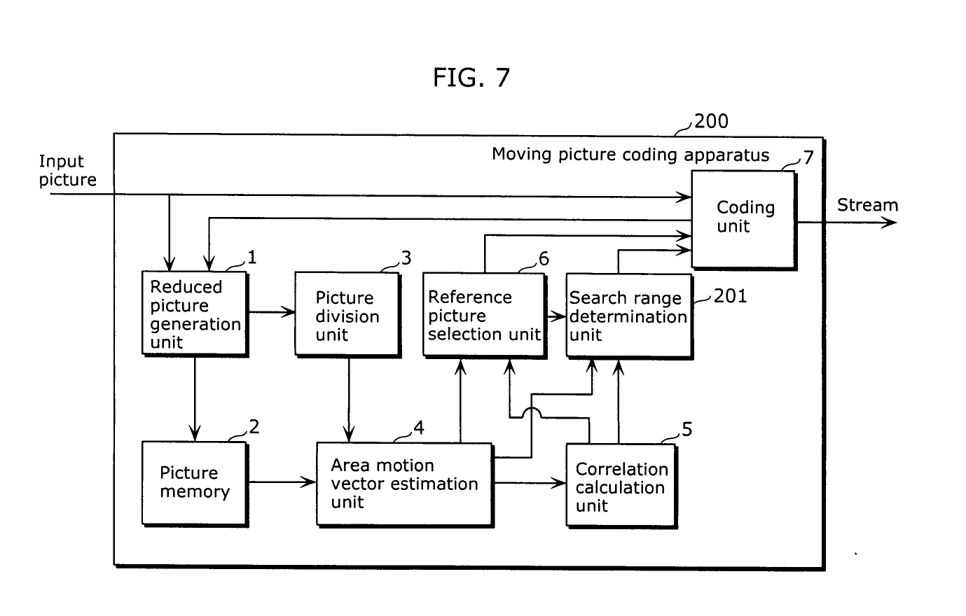

FIG. 7 is a block diagram which shows a structure of a moving picture coding apparatus including a motion vector estimation device according to the second embodiment of the present invention. Note that the same elements as those in the first embodiment are assigned the same reference numbers and the description thereof is not repeated here.

The moving picture coding apparatus 200 includes a search range determination unit 201 as shown in FIG. 7 in addition to the elements of the moving picture coding apparatus 100 in the first embodiment.

The search range determination unit 201 determines the information regarding the motion vector search range based on the area motion vector estimated by the area motion vector estimation unit 4 and the correlation of the area motion vector calculated by the correlation calculation unit 5. The information includes: the size of the motion vector search range, the shift amount of the motion vector search range, the amount of search position decimation in searching for the motion vector, and the amount of pixel decimation in calculating the evaluated values, with respect to the reference picture selected by the reference picture selection unit 6.

The structure of the coding unit 7 is same as that in the first embodiment except for the operations of the motion estimation unit 702.

The motion estimation unit 702 determines the motion vector search range for the current block using the information regarding the motion vector search range determined by the search range determination unit 201, and searches within the determined motion vector search range in the reference picture selected by the reference picture selection unit 6. By doing so, it estimates the image area which is most similar to the current block and estimates the motion vector indicating the position of the image area.

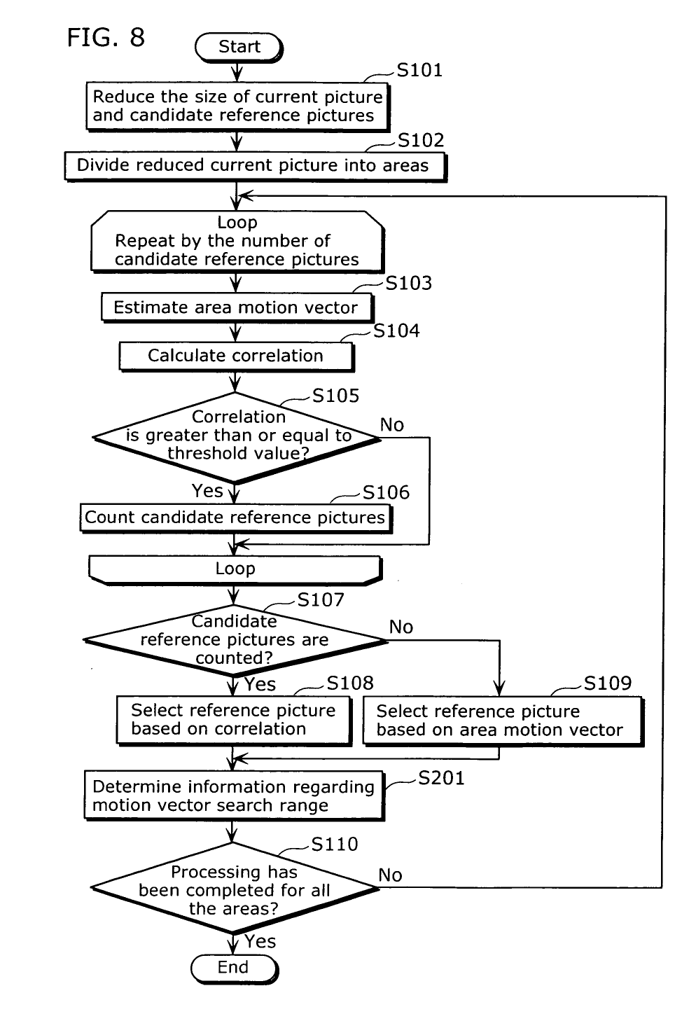

Next, a description is given as to the operations of the moving picture coding apparatus 200 including the motion vector estimation device structured as mentioned above. FIG. 8 is a flowchart which shows a sequence of operations for selecting a reference picture and determining information regarding a motion vector search range.

The operations from the process of generating a reduced current picture to be coded and respective candidate reduced reference pictures (Step S101) through the process of selecting a reference picture (Step S108 or Step S109) are same as those in the first embodiment.

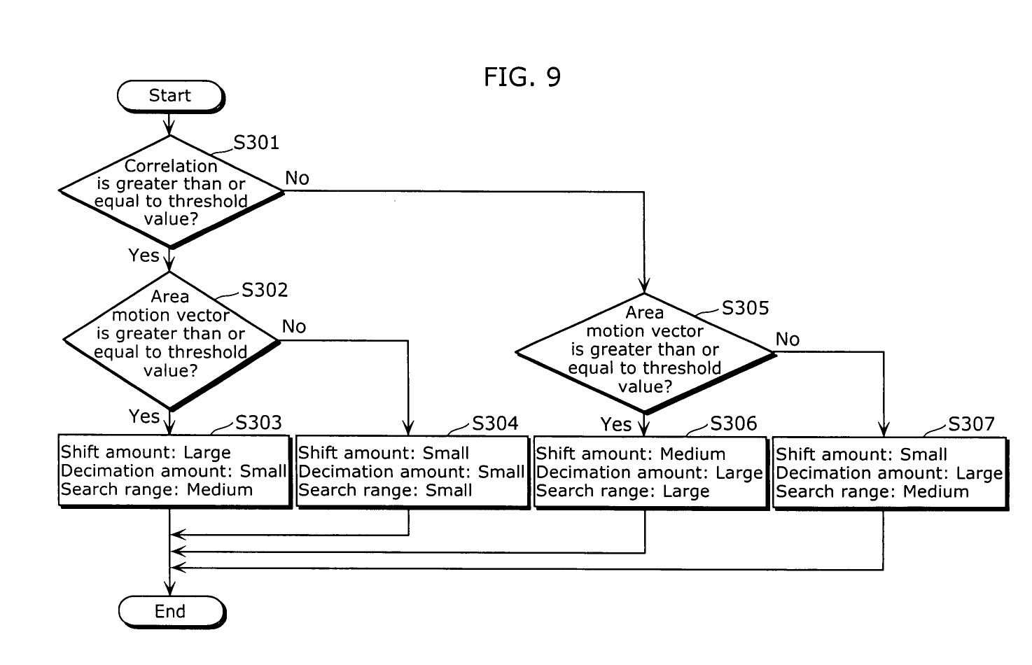

Once the reference picture is selected, the search range determination unit 201 determines the information regarding the motion vector search range (Step S201). FIG. 9 is a flowchart which shows a sequence of operations for determining this information regarding the motion vector search range.

First, the search range determination unit 201 determines whether or not the correlation of the area motion vector with respect to the selected reference picture is greater than or equal to a predetermined threshold value (Step S301). When the result shows that the correlation of the area motion vector is greater than or equal to the predetermined threshold value (Yes in Step S301), the search range determination unit 201 determines whether or not the area motion vector with respect to the selected reference picture is greater than or equal to a predetermined threshold value (Step S302). When the result shows that the area motion vector is greater than or equal to the predetermined threshold value (Yes in Step S302), the search range determination unit 201 determines to use a large shift amount of the motion vector search range, a small amount of search position decimation in the motion vector search range, and a medium-sized search range (Step S303). On the other hand, when the result shows that the area motion vector is smaller than the predetermined threshold value (No in Step S302), the search range determination unit 201 determines to use a small shift amount of the motion vector search range, a small amount of search position decimation in the motion vector search range, and a small-sized search range (Step S304).

When the correlation of the area motion vector is lower than the predetermined threshold value (No in Step S301), the search range determination unit 201 determines whether or not the area motion vector with respect to the selected reference picture is greater than or equal to the predetermined threshold value (Step S305). When the result shows that the area motion vector is greater than or equal to the predetermined threshold value (Yes in Step S305), the search range determination unit 201 determines to use a medium shift amount of the motion vector search range, a large amount of search position decimation in the motion vector search range, and a large search range (Step S306). On the other hand, when the result shows that the area motion vector is smaller than the threshold value (No in Step S305), the search range determination unit 201 determines to use a small shift amount of the motion vector search range, a large amount of search position decimation in the motion vector search range, and a medium-sized search range (Step S307).

When the correlation is high, it can be judged that the matching degree between the images is high, and that the accuracy of the area motion vector AMV is high. When the accuracy of the area motion vector is high, it can be judged that the accuracy of the motion vector of the current block does not fluctuate so much. Therefore, as shown above, when the correlation is high, a search range is determined to be smaller compared with the one when the correlation is low. In addition, in this case, the amount of search position decimation is determined to be small. On the other hand, when the correlation is low, it can be judged that the matching degree between the images is low, and that the accuracy of the area motion vector is low. When the accuracy of the area motion vector is low, it can be judged that the accuracy of the motion vector of the current block fluctuates greatly. Therefore, as shown above, when the correlation is low, a search range is determined to be larger compared with the one when the correlation is high. In addition, since the processing amount increases when the search range is determined to be larger, the amount of search position decimation is determined to be large.

Once the information regarding the motion vector search range is determined as described above, the search range determination unit 201 determines whether or not the processing for all the areas has been completed (Step S110). As a result, when the processing for all the areas has been completed (Yes in Step 5110), the processing for one current picture to be coded is ended. On the other hand, when the processing for all the areas has not been completed (No in Step 5110), the operations from the process of estimating the area motion vector (Step S103) through the process of determining the information regarding the motion vector search range (Step S201) are repeated.

Next, a description is given as to a determination of a motion vector search range and a motion vector search performed by the motion estimation unit 702 of the coding unit 7 using the information regarding the motion vector search range determined as mentioned above.

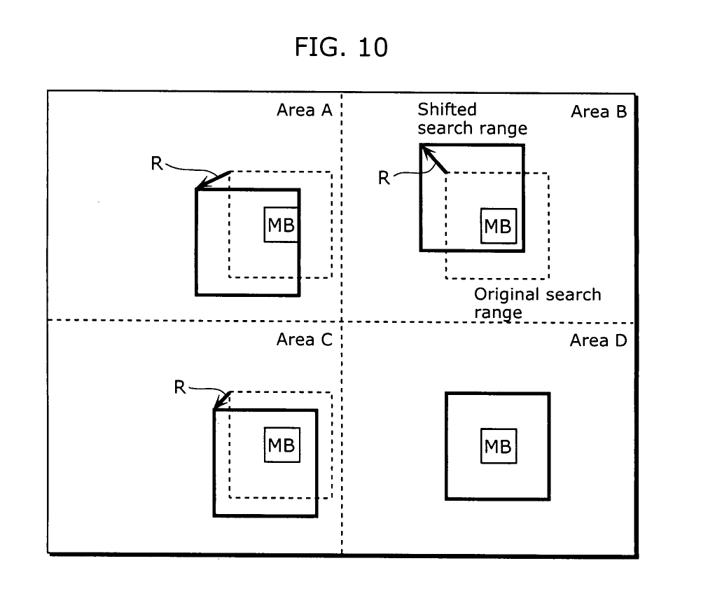

First, how to shift the position of the search range is described. FIG. 10 is a diagram which illustrates how to shift the position of the motion vector search range.

Similarly to the case of a reduced current picture to be coded, a current picture to be coded is divided into two both horizontally and vertically so as to be divided into four areas. The respective areas correspond to the areas A to D of the reduced current picture. The search range of the standard position is enclosed by the dotted lines shown in FIG. 10, and the enclosed search range includes a current block at its center. The motion estimation unit 702 shifts the search range from the standard position by the shift amount R of the search range in each area determined by the search range determination unit 201 so as to search a motion vector within the range enclosed by the solid lines shown in FIG. 10. For example, when the shift amount R is determined, the areas are respectively shifted by the shift amount R, as shown in the areas A, B and C of FIG. 10. When the shift amount R is 0, the search range is the same as the search range of the standard position, as shown in the area D of FIG. 10.

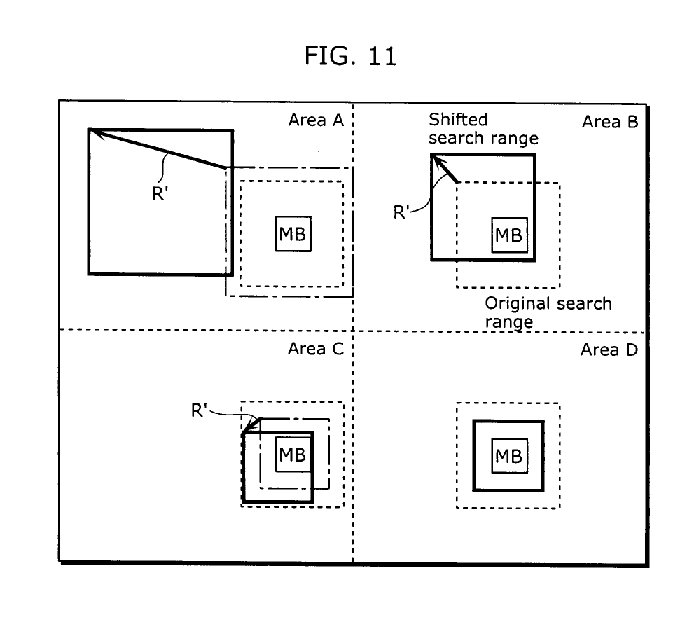

Next, the size of the motion vector search range is described. FIG. 11 is a diagram which illustrates the size of a motion vector search range and how to shift the position of the range.

Similarly to the above, the search range of the standard position is enclosed by the dotted lines shown in FIG. 11, and the enclosed search range includes a current block at its center. The motion estimation unit 702 expands the search range of the standard position by a predetermined amount, keeps the expanded search range unchanged, or reduces it by a predetermined amount, according to the size of the motion vector search range in each area determined by the search range determination unit 201. Then, it shifts the search range by the shift amount R′, and searches a motion vector within the range enclosed by the solid lines shown in FIG. 11. For example, when the search range is large and the shift amount R′ is determined, the search range of the standard position is expanded by a predetermined amount as shown in the area A of FIG. 11, and the expanded search range is shifted by the shift amount R′. In addition, when the size of the search range is medium and the shift amount R′ is determined, the search range of the standard position is kept unchanged as shown in the area B in FIG. 11, and the search range is shifted by the shift amount R′. When the search range is small and the shift amount R′ is determined, the search range of the standard position is reduced by a predetermined amount as shown in the area C in FIG. 11, and the reduced search range is shifted by the shift amount R′. In addition, when the search range is small and the shift amount R′ is 0, the search range of the standard position is the reduced search range as shown in the area D in FIG. 11. It is assumed here that the search range of the standard position is expanded or reduced. However, it should be noted that the search range is not always expanded or reduced. The size of the search range may be changed to a predetermined size and then the search range of the predetermined size may be shifted by the shift amount of the search range.

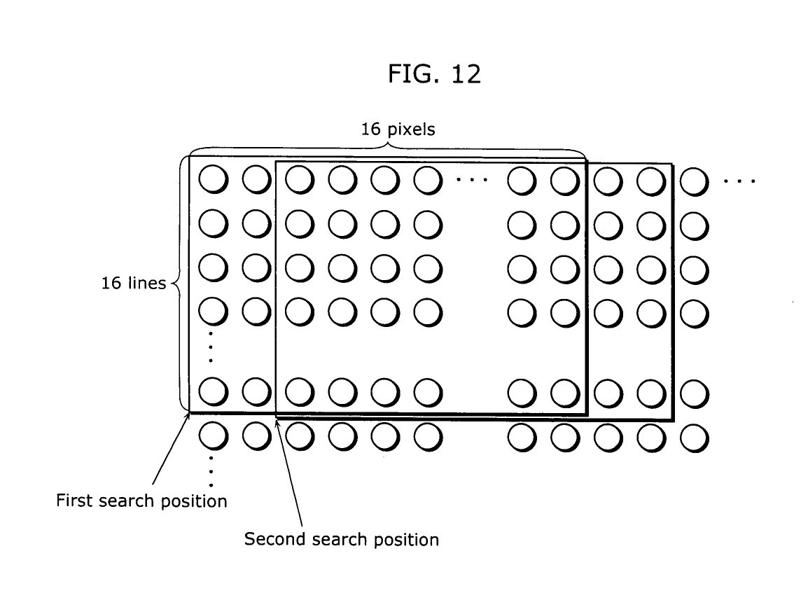

Next, the amount of search position decimation is described. FIG. 12 is a diagram which illustrates an amount of search position decimation.

In the case where the search range is expanded by the search range determination unit 201, when evaluation values are respectively calculated at all the positions and motion vectors are searched, the processing amount increases in proportion to the size of the search range. As a method of expanding the search range without increasing the processing amount, search position decimation is performed. For example, in the case of performing one-half horizontal search position decimation, the motion estimation unit 702 performs a search for each position while horizontally shifting the position every other pixel, as shown in FIG. 12, in the order of the first search position, the second search position, the third search position and so on.

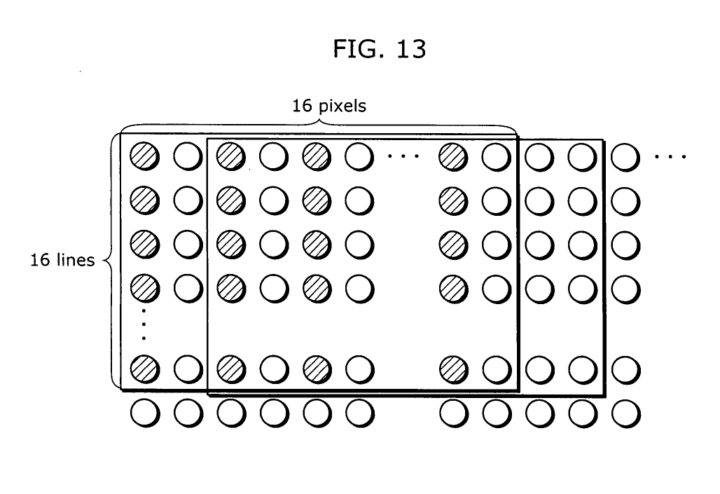

Next, the amount of pixel decimation in calculating the evaluation values is described. FIG. 13 is a diagram which illustrates the amount of pixel decimation in calculating the evaluation values at the time of searching motion vectors.

The purpose of using pixel decimation in calculating the evaluation values at the time of searching motion vectors is the same as the purpose of using search position decimation. The use of search position decimation is one of the methods of expanding the search range while keeping the processing amount. For example, in the case of performing one-half horizontal search position decimation, the motion estimation unit 702 calculates evaluation values using the data of pixels positioned horizontally at every other pixel position as shown in FIG. 13. It is general that the sum of absolute differences between all pixels in the current block and all pixels in the search position is calculated. However, here, the sum of absolute differences between only the shaded pixels in FIG. 13 and the corresponding pixels is calculated.

As described above, in the present embodiment, the information regarding the motion vector search range, such as the size of the motion vector search range, the shift amount of the motion vector search range, the amount of search position decimation at the time of searching motion vectors, and the amount of pixel decimation in calculating the evaluation values of the blocks, are determined based on the area motion vector estimated by the area motion vector estimation unit 4 and the correlation of the area motion vector estimated by the correlation calculation unit 5. Accordingly, it is possible to determine the motion vector search range efficiently and thus estimate the motion vector with high accuracy.

In the present embodiment, information regarding a motion vector search range is determined for each of the four cases determined by the following two conditions: whether or not the size of an area motion vector is greater than or equal to a predetermined threshold value; and whether or not the correlation of an area motion vector is greater than or equal to a predetermined threshold value. But the present invention is not limited to such determination for each of the four cases. For example, the information may be determined for each of more detailed cases determined by three or more conditions based on two or more threshold values.

### Third Embodiment

In the second embodiment, a description is given as to the case where one motion vector search range is prepared at the time of estimating motion vectors in the motion estimation unit 702. In the present embodiment, a description is made as to the case where plural motion vector search ranges are prepared.

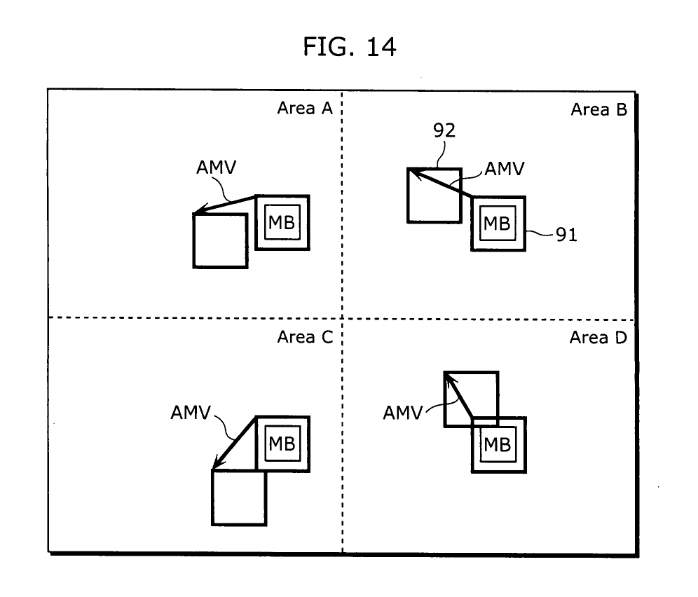

FIG. 14 is a diagram which illustrates how to set a search range in the motion vector estimation device according to the third embodiment of the present invention. Since the structure of the motion vector estimation device is the same as that of the motion vector estimation device in the second embodiment, a description thereof is not repeated here.

As shown in FIG. 14, the motion estimation unit 702 searches the search ranges 91 and 92. The search range 91 is in a rectangular area which has a predetermined size and has, at its center, a current block (macroblock) to be coded. The search range 92 is in a rectangular area at the position pointed by the area motion vector AMV. Similarly to the first embodiment, as for this search range 92, the amount of search position decimation, the amount of pixel decimation in calculating the evaluation value and the size of the search range may be changed based on the correlation and the size of the area motion vector.

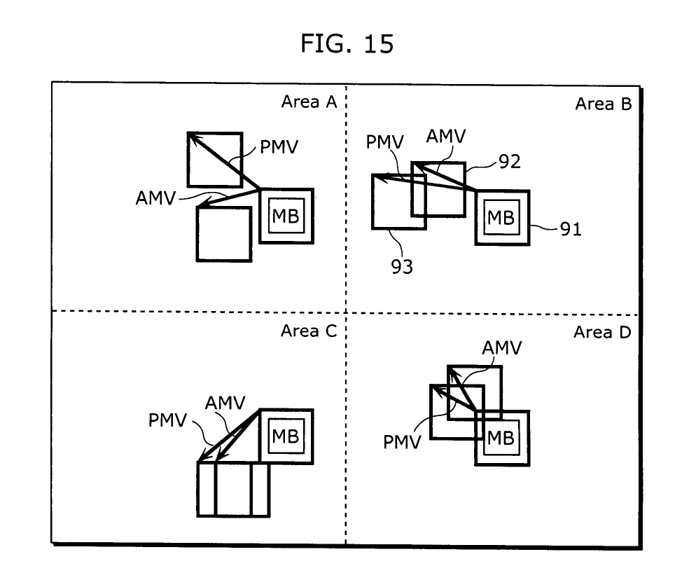

It is assumed here that two search ranges are searched, but note that it is possible to search a rectangular area which has, at its center, the position pointed by a predictive vector defined in the H.264 standard. In this case, as shown in FIG. 15, the motion estimation unit 702 searches a search range 93 of a rectangular area at the position pointed by the predictive vector PMV, in addition to the search range 91 of a rectangular area which has the predetermined size and has, at its center, the current block (macroblock) to be coded and the search range 92 of a rectangular area at the position pointed by the area motion vector AMV.

As described above, searching the search range 91 which has the current block as the center and the search range 92 determined based on the area motion vector AMV makes it possible to estimate the motion vector with high accuracy even if each of the search ranges is set to be small.

### Fourth Embodiment

In the present embodiment, a description is given as to the case of correcting the information regarding the motion vector search range with respect to a macroblock (current block to be coded) which is present in contact with a boundary between areas.

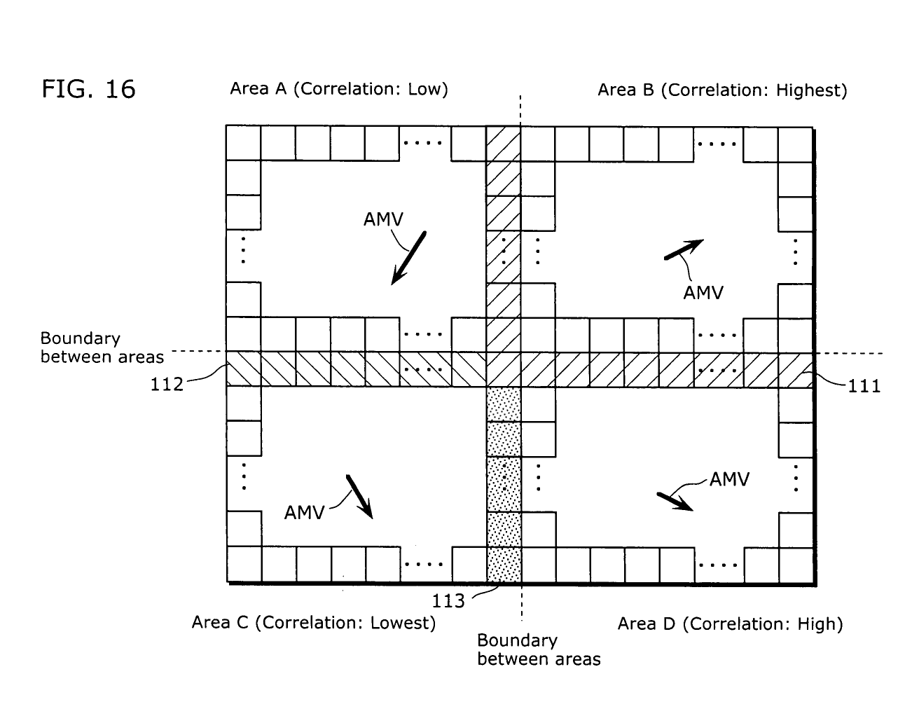

FIG. 16 is a diagram which illustrates how to correct information regarding a motion vector search range in the motion vector estimation device according to the fourth embodiment of the present invention. Since the structure of the motion vector estimation device is the same as that of the motion vector estimation device in the first embodiment, a description thereof is not repeated here.

The search range determination unit 201 corrects the information regarding the motion vector search range with respect to the macroblock which is positioned in contact with the boundary between areas, in accordance with the correlation between each set of adjacent areas. Here, it is assumed, as to the areas A to D of the current picture to be coded, as shown in FIG. 16, that the correlation values decrease in the order of areas B, D, A and C. In this case, for a macroblock which is present in an area with the lower correlation and in contact with the boundary with an area with the higher correlation, the search range determination unit 201 makes a correction so as to use the reference picture as well as the value of the area motion vector or the search range shift amount of the area with the higher correlation. For example, as to an area 111 consisting of macroblocks adjacent to the area B and included in the areas D, A and C, a correction is made so as to use the reference picture as well as the area motion vector or the search range shift amount of the area B. In addition, as to an area 112 which is adjacent to the area A and included in the area C, a correction is made so as to use the reference picture as well as the area motion vector or the search range shift amount of the area A. In addition, as to an area 113 which is adjacent to the area D and included in the area C, a correction is made so as to use the reference picture as well as the area motion vector or the search range shift amount of the area D.

As described above, the reference picture and the information regarding the motion vector search range for each macroblock which is present in contact with the boundary between the areas are corrected in accordance with the correlation between each set of adjacent areas. Therefore, it is possible to determine the motion vector search ranges efficiently, and estimate motion vectors with high accuracy.

It is assumed here that an area which is present in contact with a boundary denotes a row of macroblocks which are present in contact with the boundary. However, the processing of the present embodiment may be intended for an area consisting of plural rows of macroblocks. In addition, the number of macroblocks to be corrected may be changed based on the difference in correlations. Here are examples of cases where a correlation value is set between 0 and 1. When the correlation difference is 0.5 or above, the shift amount of the area motion vector or the search range is corrected by two rows of macroblocks. When the correlation difference is not less than 0.25 and less than 0.5, the shift amount of the area motion vector or the search range is corrected by a row of macroblocks. In addition, it is possible to replace the shift amount of the area motion vector or the search range of the macroblock around a boundary with another by performing linier interpolation based on the correlation.

Each functional block in the block diagrams shown in FIG. 1, FIG. 2 and FIG. 7 is realized as an LSI which is typically an integrated circuit. This LSI can be integrated into one chip, or also can be integrated into plural chips. For example, functional blocks other than a memory may be integrated into one chip. The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. Field Programmable Gate Array (FPGA) that can be programmed after manufacturing LSI or a reconfigurable processor that allows reconfiguration of the connection or setup of circuit cells inside the LSI can be used for the same purpose.

In the future, with advancement in semiconductor technology or another technology derived therefrom, a brand-new integration technology may replace LSI. The integration can be carried out by that technology. Application of biotechnology is one such possibility.

Only a unit for storing data out of the functional blocks may be structured as a separate unit, not integrated into one chip.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The motion vector estimation device and the motion vector estimation method according to the present invention are useful for an application of compressing a picture by performing inter-picture prediction in accordance with the H.264 standard, recording a TV broadcast program and taking a moving picture and the like. For example, they are applicable to personal computers, HDD recorders, DVD recorders, video cameras and mobile phones with cameras.

What is claimed is:

1. A motion vector estimation device which estimates, with respect to a reference picture, a motion vector of a current block included in a current picture to be coded, said device comprising:
a reduced picture generation unit operable to generate a reduced current picture and candidate reduced reference pictures by reducing the number of pixels of the current picture and candidate reference pictures respectively;
a picture division unit operable to divide the reduced current picture into areas;
an area motion vector estimation unit operable to estimate, for each of the candidate reduced reference pictures, an area motion vector which is a motion vector of each of the areas with respect to the candidate reduced reference picture;
a correlation calculation unit operable to calculate, for each of the candidate reduced reference pictures, a correlation between an image of each of the areas and a predicted area image generated from the area motion vector and the candidate reduced reference picture;
a reference picture selection unit operable to select, based on the correlation, at least one reference picture for each of the areas from among the candidate reference pictures; and
a motion estimation unit operable to estimate a motion vector of the current block included in the area, using the reference picture selected for the area by said reference picture selection unit.

2. The motion vector estimation device according to claim 1,
wherein said reference picture selection unit is operable to select a reference picture corresponding to the candidate reduced reference picture with a high correlation, from among the candidate reference pictures.

3. The motion vector estimation device according to claim 1,
wherein said reference picture selection unit is operable to select, based on the correlation and the area motion vector, at least one reference picture for each of the areas from the candidate reference pictures.

4. The motion vector estimation device according to claim 3,
wherein said reference picture selection unit is operable to determine whether or not the correlation calculated for each of the candidate reduced reference pictures is greater than or equal to a predetermined threshold value, and (i) when any of the candidate reduced reference pictures have correlations which are greater than or equal to the predetermined threshold value, to select a reference picture corresponding to the candidate reduced reference picture with a high correlation, from among the candidate reduced reference pictures having the correlations which are greater than or equal to the predetermined threshold value, and (ii) when none of the candidate reduced reference pictures have correlations which are greater than or equal to the predetermined threshold value, to select a reference picture corresponding to the candidate reduced reference picture with a small area motion vector.

5. The motion vector estimation device according to claim 1, further comprising
a search range determination unit operable to determine information regarding a motion vector search range for the current block based on the area motion vector,
wherein said motion estimation unit is operable to determine the motion vector search range in the reference picture selected by said reference picture selection unit, based on the information regarding the motion vector search range determined by said search range determination unit, and to estimate the motion vector of the current block by searching within the determined motion vector search range.

6. The motion vector estimation device according to claim 3,
wherein said search range determination unit is operable to determine the information regarding the motion vector search range based on the area motion vector and the correlation.

7. A motion vector estimation method of estimating, with respect to a reference picture, a motion vector of a current block included in a current picture to be coded, said method comprising:
generating a reduced current picture and candidate reduced reference pictures by reducing the number of pixels of the current picture and candidate reference pictures respectively;
dividing the reduced current picture into areas;
estimating, for each of the candidate reduced reference pictures, an area motion vector which is a motion vector of each of the areas with respect to the candidate reduced reference picture;
calculating, for each of the candidate reduced reference pictures, a correlation between an image of each of the areas and a predicted area image generated from the area motion vector and the candidate reduced reference picture;
selecting, based on the correlation, at least one reference picture for each of the areas from among the candidate reference pictures; and
estimating a motion vector of the current block included in the area, using the reference picture selected for the area in said selecting.

8. An integrated circuit for estimating, with respect to a reference picture, a motion vector of a current block included in a current picture to be coded, said circuit comprising:
a reduced picture generation unit operable to generate a reduced current picture and candidate reduced reference pictures by reducing the number of pixels of the current picture and candidate reference pictures respectively;
a picture division unit operable to divide the reduced current picture into areas;
an area motion vector estimation unit operable to estimate, for each of the candidate reduced reference pictures, an area motion vector which is a motion vector of each of the areas with respect to the candidate reduced reference picture;
a correlation calculation unit operable to calculate, for each of the candidate reduced reference pictures, a correlation between an image of each of the areas and a predicted area image generated from the area motion vector and the candidate reduced reference picture;
a reference picture selection unit operable to select, based on the correlation, at least one reference picture for each of the areas from among the candidate reference pictures; and
a motion estimation unit operable to estimate a motion vector of the current block included in the area, using the reference picture selected for the area by said reference picture selection unit.
